(19) United States
(12) Patent Application Publication
(10) Pub. No.: US 2020/0125836 A1
(43) Pub. Date: Apr. 23, 2020

(54) Training Method for Descreening System, Descreening Method, Device, Apparatus and Medium

(71) Applicant: PING AN TECHNOLOGY (SHENZHEN) CO., LTD., Shenzhen, Guangdong (CN)

(72) Inventor: Lingling Xu, Shenzhen, Guangdong (CN)

(21) Appl. No.: 16/627,755

(22) PCT Filed: Jun. 25, 2018
(86) PCT No.: PCT/CN2018/092569

§ 371 Date: Dec. 30, 2019

(30) Foreign Application Priority Data
Apr. 20, 2018 (CN) 201810360251.9

(51) Int. Cl. G06K 9/00; G06N 3/08; G06K 9/62; G06N 3/04

(52) U.S. Cl. CPC G06K 9/00281; G06N 3/084; G06N 3/0454; G06K 9/00288; G06K 9/6256

(57) ABSTRACT

Provided are training method for descreening system, descreening method, device, apparatus and medium. The training method for descreening system comprises: obtaining a first error function based on a halftone position and a preset label value, obtaining a second error function based on simulation images and non-halftone training samples, obtaining a third error function and a fourth error function according to a discrimination result, obtaining a fifth error function according to feature A and feature B, and based on the characteristics of Generative Adversarial Networks, according to the second error function, third error function, fourth error function and fifth error function, the sixth error function and seventh error function are respectively obtained, then an error function is constructed according to the errors generated by training, and the network parameters of each part of the models in the descreening system are updated by backpropagation of error function.

The present application is based on, and claims priority from, Chinese invention patent application No. 201810360251.9, filed Apr. 20, 2018, entitled “Training method for descreening system, descreening method, device, apparatus and medium”.

### TECHNICAL FIELD

The application relates to the field of image processing, in particular to training method for descreening system, descreening method, device, apparatus and medium.

### BACKGROUND

Nowadays, ID photos are screened in order to improve security. However, it is difficult to perform facial feature points detection on the screened ID photos, which makes it impossible to directly recognize faces. Therefore, before performing the face feature points detection, the photos should be descreened, so as to realize face recognition. At present, the removal effect of halftone pattern by the existing descreening model in the industry is relatively unsatisfactory, faces on the descreened ID photos or images are likely to deform.

### SUMMARY

An embodiment of the application provides a training method for descreening system, a device, an apparatus and a medium to solve the problem of poor descreening effects of the current descreening model.

A training method for descreening system, comprising:

extracting samples to be trained, wherein the to-be-trained samples comprise equal numbers of halftone training samples and non-halftone training samples;

inputting the halftone training samples into a halftone extractor, extracting a halftone position, obtaining a first error function based on the halftone position and a preset label value, and updating network parameters of the halftone extractor according to the first error function;

inputting the halftone position and the halftone training samples into a Generative Adversarial Networks (GANs) generator to generate a simulation image, and obtaining a second error function based on the simulation image and the non-halftone training samples;

inputting the simulation image and the non-halftone training samples into a Generative Adversarial Networks discriminator to obtain a discrimination result, and obtaining a third error function and a fourth error function according to the discrimination result;

extracting feature A of the simulation image and feature B of the non-halftone training samples by adopting a pre-trained face recognition model, and obtaining a fifth error function according to the feature A and the feature B;

obtaining a sixth error function, and updating network parameters of the Generative Adversarial Networks generator according to the sixth error function, wherein the sixth error function=the second error function+third error function+fifth error function;

obtaining a seventh error function, and updating network parameters of the Generative Adversarial Networks discriminator according to the seventh error function, wherein the seventh error function=the fourth error function+fifth error function.

A training device for descreening system, comprising:

a training sample acquisition module, configured for extracting samples to be trained, wherein the to-be-trained samples comprise equal numbers of halftone training samples and non-halftone training samples;

a first error function acquisition module, configured for inputting the halftone training samples into a halftone extractor, extracting a halftone position, obtaining a first error function based on the halftone position and a preset label value, and updating network parameters of the halftone extractor according to the first error function;

a second error function acquisition module, configured for inputting the halftone position and the halftone training samples into a Generative Adversarial Networks (GANs) generator to generate a simulation image, and obtaining a second error function based on the simulation image and the non-halftone training samples;

a discrimination result acquisition module, configured for inputting the simulation image and the non-halftone training samples into a Generative Adversarial Networks discriminator to obtain a discrimination result, and obtaining a third error function and a fourth error function according to the discrimination result;

a fifth error function acquisition module, configured for extracting feature A of the simulation image and feature B of the non-halftone training samples by adopting a pre-trained face recognition model, and obtaining a fifth error function according to the feature A and the feature B;

a sixth error function acquisition module, configured for obtaining a sixth error function, and updating network parameters of the Generative Adversarial Networks generator according to the sixth error function, wherein the sixth error function=the second error function+third error function+fifth error function;

a seventh error function acquisition module, configured for obtaining a seventh error function, and updating network parameters of the Generative Adversarial Networks discriminator according to the seventh error function, wherein the seventh error function=the fourth error function+fifth error function.

Another embodiment of the application also provides a descreening method, a device, an apparatus and a medium to solve the problem of poor descreening effects in Prior art.

A descreening method, comprising:

inputting a to-be-descreened image into a halftone extractor, extracting a halftone position of the to-be-descreened image; the halftone extractor is obtained by adopting the training method for descreening system;

inputting the halftone position of the to-be-descreened image and the to-be-descreened image into a Generative Adversarial Networks generator, generating a target descreened image; the Generative Adversarial Networks generator is obtained by adopting the training method for descreening system.

A descreening device, comprises:

a halftone position extraction module, configured for inputting a to-be-descreened image into a halftone extractor, extracting a halftone position of the to-be-descreened image; the halftone extractor is obtained by adopting the training method for descreening system;

a target descreened image generation module, configured for inputting the halftone position of the to-be-descreened image and the to-be-descreened image into a Generative Adversarial Networks generator, generating a target descreened image; the Generative Adversarial Networks generator is obtained by adopting the training method for descreening system.

A computer apparatus, comprising a memory, a processor, and computer readable instructions stored in the memory and executed by the processor, wherein the processor implements the following steps when executing the computer readable instructions:

extracting samples to be trained, wherein the to-be-trained samples comprise equal numbers of halftone training samples and non-halftone training samples; inputting the halftone training samples into a halftone extractor, extracting a halftone position, obtaining a first error function based on the halftone position and a preset label value, and updating network parameters of the halftone extractor according to the first error function;

inputting the halftone position and the halftone training samples into a Generative Adversarial Networks (GANs) generator to generate a simulation image, and obtaining a second error function based on the simulation image and the non-halftone training samples;

inputting the simulation image and the non-halftone training samples into a Generative Adversarial Networks discriminator to obtain a discrimination result, and obtaining a third error function and a fourth error function according to the discrimination result;

extracting feature A of the simulation image and feature B of the non-halftone training samples by adopting a pre-trained face recognition model, and obtaining a fifth error function according to the feature A and the feature B;

obtaining a sixth error function, and updating network parameters of the Generative Adversarial Networks generator according to the sixth error function, wherein the sixth error function=the second error function+third error function+fifth error function;

obtaining a seventh error function, and updating network parameters of the Generative Adversarial Networks discriminator according to the seventh error function, wherein the seventh error function=the fourth error function+fifth error function.

A computer apparatus, comprising a memory, a processor, and computer readable instructions stored in the memory and executed by the processor, wherein the processor implements the following steps when executing the computer readable instructions:

inputting a to-be-descreened image into a halftone extractor, extracting a halftone position of the to-be-descreened image; the halftone extractor is obtained by updating network parameters of the halftone extractor based on a first error function, by adopting the training method for descreening system;

inputting the halftone position of the to-be-descreened image and the to-be-descreened image into a Generative Adversarial Networks generator, generating a target descreened image; the Generative Adversarial Networks generator is obtained by updating network parameters of the Generative Adversarial Networks generator based on a sixth error function, by adopting the above-mentioned training method for descreening system.

A computer readable storage medium storing computer readable instructions, wherein when the computer readable instructions are executed by a processor, the following steps are implemented:

extracting samples to be trained, wherein the to-be-trained samples comprise equal numbers of halftone training samples and non-halftone training samples;

inputting the halftone training samples into a halftone extractor, extracting a halftone position, obtaining a first error function based on the halftone position and a preset label value, and updating network parameters of the halftone extractor according to the first error function;

inputting the halftone position and the halftone training samples into a Generative Adversarial Networks (GANs) generator to generate a simulation image, and obtaining a second error function based on the simulation image and the non-halftone training samples;

inputting the simulation image and the non-halftone training samples into a Generative Adversarial Networks discriminator to obtain a discrimination result, and obtaining a third error function and a fourth error function according to the discrimination result;

extracting feature A of the simulation image and feature B of the non-halftone training samples by adopting a pre-trained face recognition model, and obtaining a fifth error function according to the feature A and the feature B;

obtaining a sixth error function, and updating network parameters of the Generative Adversarial Networks generator according to the sixth error function, wherein the sixth error function=the second error function+third error function+fifth error function;

obtaining a seventh error function, and updating network parameters of the Generative Adversarial Networks discriminator according to the seventh error function, wherein the seventh error function=the fourth error function+fifth error function.

A computer readable storage medium storing computer readable instructions, wherein when the computer readable instructions are executed by a processor, the following steps are implemented:

inputting a to-be-descreened image into a halftone extractor, extracting a halftone position of the to-be-descreened image; the halftone extractor is obtained by updating network parameters of the halftone extractor based on a first error function, by adopting the training method for descreening system;

inputting the halftone position of the to-be-descreened image and the to-be-descreened image into a Generative Adversarial Networks generator, generating a target descreened image;

the Generative Adversarial Networks generator is obtained by updating network parameters of the Generative Adversarial Networks generator based on a sixth error function, by adopting the above-mentioned training method for descreening system.

In the training method for descreening system, device, apparatus and medium provided by the embodiment of the application, obtaining a first error function (e_loss) based on a halftone pattern position and a preset label value, obtaining a second error function (l_loss) based on simulation images and non-halftone training samples, obtaining a third error function (gan_g_loss) and a fourth error function (gan_d_loss) according to a discrimination result, obtaining a fifth error function (i_loss) according to feature A and feature B, and based on the characteristics of Generative Adversarial Networks (including Generative Adversarial Networks Generator and Generative Adversarial Networks Discriminator), according to the second error function, third error function, fourth error function and fifth error function, the sixth error function (g_loss) and seventh error function (d_loss) are respectively obtained, and the corresponding error function is constructed according to the errors generated by training the descreening system, and the network parameters of each part of the models in the descreening system are updated by backpropagation of error function, so as to achieve an efficient and effective training for the descreening system. The descreening system covers every factor affecting the descreening effects of the descreening system in the training process of the descreening system, so that when the descreening system performs descreening on images, the descreening effects are very good.

The descreening method, device, apparatus and medium provided by the embodiment of the application, extract halftone positions of the to-be-descreened image by inputting the to-be-descreened image into a halftone extractor, and input the halftone positions of the to-be-descreened image and the to-be-descreened image into a Generative Adversarial Networks generator, to generate a target descreened image. The descreening method for descreening halftone patterns has excellent effects.

### BRIEF DESCRIPTION OF THE DRAWINGS

In order to more clearly explain the technical solution of the embodiments of this application, the following will briefly describe the drawings of the embodiments of this application. Obviously, the drawings in the following description are only some embodiments of this application. For those skilled in the art, other drawings can be obtained according to these drawings without the exercise of inventive faculty.

FIG. 1 is an application environment diagram of the training method for descreening system according to an embodiment of the present application;

FIG. 2 is a flowchart of the training method for descreening system according to an embodiment of the present application;

FIG. 3 is a concrete flowchart of step S20 in FIG. 2;

FIG. 4 is a concrete flowchart of step S50 in FIG. 2;

FIG. 5 is a flowchart of the descreening method according to an embodiment of the present application;

FIG. 6 is a schematic diagram of the training device for descreening system according to an embodiment of the present application;

FIG. 7 is a schematic diagram of the descreening device according to an embodiment of the present application;

FIG. 8 is a schematic diagram of the computer apparatus according to an embodiment of the present application.

### DETAILED DESCRIPTION OF DISCLOSED EMBODIMENTS

In the following, the technical solutions in the embodiments of the application will be described clearly and completely with reference to the drawings in the embodiments of the application. Obviously, the described embodiments are parts of the embodiments of the application, not all of the embodiments. Based on the embodiments in this application, all other embodiments obtained by those of ordinary skill in the art without the exercise of inventive faculty are within the scope of protection.

The descreening system of the training method for descreening system comprises a halftone extractor, a face recognition model, a Generative Adversarial Networks generator and a Generative Adversarial Networks discriminator, and the process of training the descreening system is to train the network parameters of each component in the descreening system.

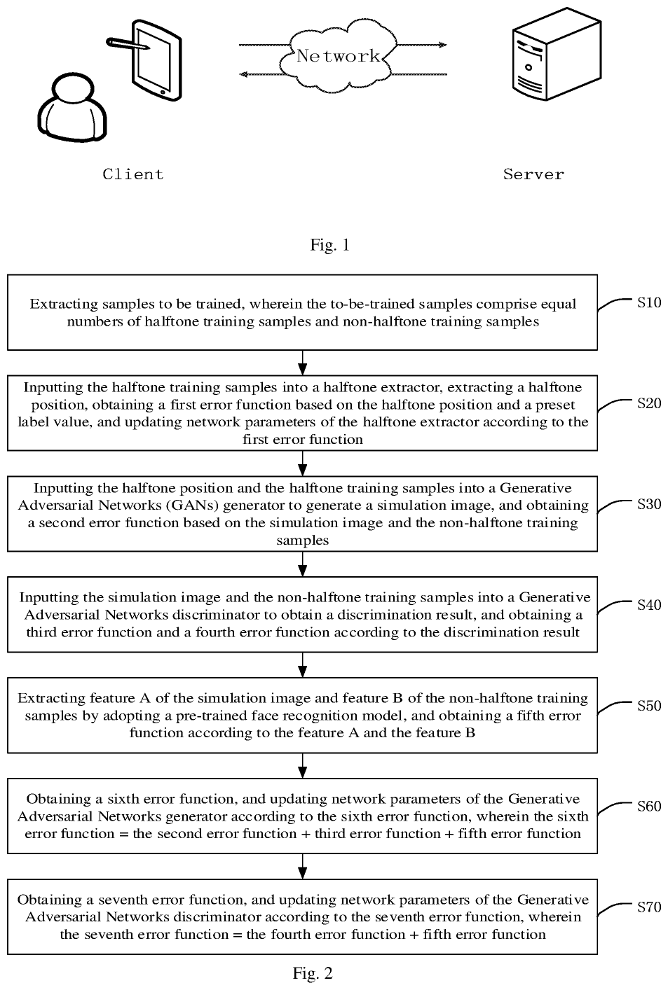

FIG. 1 shows an application environment of the training method for descreening system provided by the embodiments of the application. The application environment of the the training method for descreening system comprises a server and a client, wherein the server and the client are connected through a network, and the client is equipment capable of carrying out man-machine interaction with users, including but not limited to computers, smart phones, tablets and other equipment, and the server can be specifically realized by independent servers or a server cluster consisting of a plurality of servers. The training method for descreening system provided by the embodiments of the application is applied to the server.

As shown in FIG. 2, FIG. 2 shows a flowchart of the training method for descreening system in the embodiment of the present application. The voice distinguishing method includes the following steps:

S10: extracting samples to be trained, wherein the to-be-trained samples comprise equal numbers of halftone training samples and non-halftone training samples.

Wherein, the halftone training sample refers to the screened images used for training the descreening system, and the non-halftone training sample refers to the unscreened images (without halftone) used for training the descreening system. The to-be-trained samples of halftone training sample and non-halftone training sample are the same except on the halftone. For example, a set of halftone training samples and an equal number of non-halftone training samples for training the descreening system are taken from a screened ID photo of user A and an unscreened ID photo of user A. Equal number refers that the ratio between the halftone training samples and the non-halftone training samples is 1:1.

In one embodiment, a to-be-trained sample is extracted, and the to-be-trained samples comprise equal numbers of halftone training samples and non-halftone training samples, the halftone training samples and the equal number of non-halftone training samples can specifically be halftone images and non-halftone images adopted from a large number of people's ID photos, the difference between the two lies only in the presence or absence of halftone patterns. The size of the halftone training samples and the equal number of non-halftone training samples should be large enough, if the sample size is too small, the descreening system cannot be fully trained, which would result in poor descreening effects for the descreening system. In one embodiment, the size can specifically be 40,000 sets of training samples with and without halftone. Understandably, the difference between the halftone training sample and the non-halftone training sample lies only in the presence or absence of halftone patterns, so sufficient training can be conducted according to the difference to extract the distinguishing features between the halftone training sample and the equal number of non-halftone training samples, which lays a foundation for effective training of the descreening system.

S20: inputting the halftone training samples into a halftone extractor, extracting a halftone position, obtaining a first error function based on the halftone position and a preset label value, and updating network parameters of the halftone extractor according to the first error function.

Wherein, the halftone extractor here is a pre-trained halftone extraction model capable of extracting halftone positions of images. The halftone position refers to the relative position of halftone in the halftone training sample (e.g. halftone ID photo). The label value refers to the actual situation of the halftone position in the halftone training sample and the corresponding non-halftone training sample (i.e. the label value is obtained by manually labeling in advance according to the actual situation). The label value is used to calculate the error between the halftone position extracted by the halftone extractor and the actual halftone position, and to construct the corresponding error function, update the network parameters in the halftone extractor according to the error function (the halftone extractor is trained by neural network model, therefore the halftone extractor includes the network parameters in neural network). The first error function (e_loss) refers to an error function constructed according to the error between the halftone position extracted by the halftone extractor and a preset label value.

In one embodiment, the halftone training samples are input into a network extractor, the network extractor extracts the halftone position of the halftone training sample, and the extracted halftone position is compared with a preset label value, to construct an appropriate error function e_loss to measure the error between the extracted halftone position and the preset label value. Understandably, there is an error between the halftone position extracted from the halftone training sample by using the pre-trained halftone extractor and the actual situation (the actual position of the halftone position, i.e. the label value). Since the halftone training samples need to be trained in other model parts (such as the Generative Adversarial Networks generator and a Generative Adversarial Networks discriminator) of the descreening system, the halftone training samples should be used to train the network extractor here. So as to optimize the network extractor, enable the network extractor to be more accurate when extracting the halftone position of the halftone training samples, and improve the training accuracy of the subsequent descreening system.

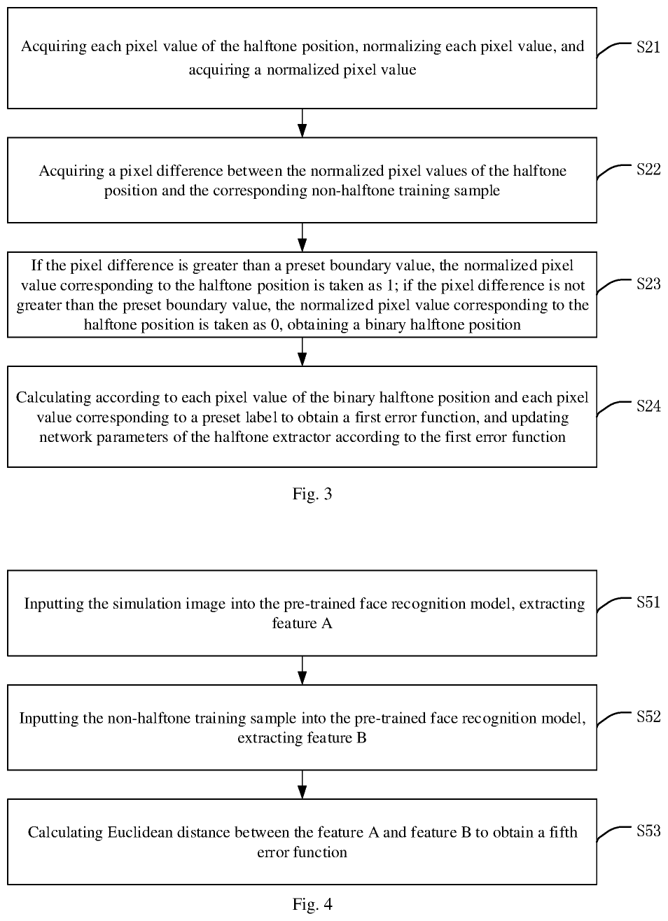

In a specific embodiment, as shown in FIG. 3, the step S20 of inputting the halftone training samples into a halftone extractor, extracting a halftone position, obtaining e_loss based on the halftone position and a preset label value, and updating network parameters of the halftone extractor according to e_loss includes the following steps:

S21: acquiring each pixel value of the halftone position, normalizing each pixel value, and acquiring a normalized pixel value; wherein the formula for acquiring normalized pixel values is

$$y = \frac{x - MinValue}{MaxValue - MinValue} ,$$

MaxValue represents the maximum value of all pixel values of the halftone position, MinValue represents the minimum value of all pixel values of the halftone position, X is each pixel value, and Y is normalized pixel value.

In one embodiment, each pixel value of the halftone position is obtained based on the halftone extractor, and each pixel value is normalized to a range of [0,1] to obtain a normalized pixel value (i.e., the pixel value after normalization). Generally, the pixel values of an image have pixel-levels of 2⁸, 2¹², 2¹⁶ and etc. An image may contain a large number of different pixel values, which makes the calculation inconvenient. Therefore, by normalizing the pixel values, each pixel value in the halftone position is compressed in the same range, which can simplify the calculation and speed up the training process of descreening system.

S22: acquiring a pixel difference between the normalized pixel values of the halftone position and the corresponding non-halftone training sample.

In one embodiment, the normalized pixel value of non-halftone training sample is first calculated and obtained (the pixel value of non-halftone training sample can also be normalized in advance, and need not be normalized when calculating), the normalized pixel value of the halftone position obtained in step S21 and the corresponding normalized pixel value of non-halftone training sample are subtracted from each other, and an absolute value is obtained (the formula is |xᵢ−yᵢ| wherein xᵢ is the normalized pixel value corresponding to the i-th pixel value of the halftone position, yᵢ represents the normalized pixel value corresponding to the i-th pixel value corresponding to xᵢ of the non-halftone training sample), and the pixel difference between the normalized pixel values of the halftone position and the corresponding non-halftone training sample is obtained. Understandably, the pixel difference between the halftone and non-halftone is very obvious, therefore the use of pixel difference can well represent the halftone position.

S23: if the pixel difference is greater than a preset boundary value, the normalized pixel value corresponding to the halftone position is taken as 1; if the pixel difference is not greater than the preset boundary value, the normalized pixel value corresponding to the halftone position is taken as 0, obtaining a binary halftone position.

Wherein, the preset boundary value refers to a preset reference value used to divide the pixel differences into two types of values: 0 and 1. The binary halftone position refers to the halftone position obtained after comparing the normalized pixel value with the preset boundary value and changing the normalized pixel value of the halftone position.

In one embodiment, the preset boundary value may be set to 0.3. In this case, if the pixel difference is greater than 0.3, the normalized pixel value corresponding to the halftone position is taken as 1; if the pixel difference is not greater than 0.3, the normalized pixel value corresponding to the halftone position is taken as 0. The binary halftone position obtained by the preset boundary value can represent the halftone position concisely according to the characteristics of the halftone on the image, and the training for descreening system can be accelerated.

S24: calculating according to each pixel value of the binary halftone position and each pixel value corresponding to a preset label to obtain a first error function, and updating network parameters of the halftone extractor according to the first error function; wherein the calculation formula of the first error function is

$$e\_loss = - \frac{1}{n} {\sum }_{i = 1}^{n} [ {y}_{i} log {x}_{i} + ( 1 - {y}_{i} ) log ( 1 - {x}_{i} ) ] ,$$

wherein n is the number of pixel values, xᵢ represents the i-th pixel value of the binary halftone position, yᵢ represents a preset label value and is the binary halftone position corresponding to xᵢ.

Wherein, each pixel value corresponding to the preset label value is represented by values of 1 or 0, the pixel value corresponding to the halftone position is 1 (i.e. “true” in the actual situation), and the pixel value other than the halftone position is 0 (i.e. “false” in the actual situation).

In one embodiment, calculation is performed according to each pixel value of the binary halftone position and each pixel value corresponding to the preset label value, and the calculation process is the process of obtaining e_loss. Wherein, the calculation formula of e_loss is

$$e\_loss = - \frac{1}{n} {\sum }_{i = 1}^{n} [ {y}_{i} log {x}_{i} + ( 1 - {y}_{i} ) log ( 1 - {x}_{i} ) ] ,$$

n is the number of pixel values, xᵢ represents the i-th pixel value of the binary halftone position, yᵢ represents a preset label value and is the binary halftone position corresponding to xᵢ. The e_loss refers to an error function constructed according to the error between the halftone position extracted by a halftone extractor and a preset label value, the error function can effectively reflect the error between the halftone position extracted by halftone extractor and the actual situation, and can carry out error backpropagation on the network parameters in halftone extractor and update the network parameters in halftone extractor according to the error function constructed by the error. The gradient descent method is adopted in the step of updating the network parameters by backpropagation of error function. The gradient descent method here is not limited to batch gradient descent method, mini-batch gradient descent method and stochastic gradient descent method. The gradient descent method can find the minimum value of the error function and obtain the minimized error function, thus effectively updating the network parameters in the halftone extractor and achieving better effect of extracting the halftone position by the halftone extractor after updating the network parameters.

It should be noted that by using steps S21-S24, updating the halftone extractor according to the pixel value to extract the halftone position can be applicable to different halftone types (types of halftone positions), that is, a plurality of different halftone types can be trained together in the stage of training halftone extractor; In addition, in the stage of halftone extraction, any types of halftone positions can be directly extracted by the halftone extractor, and there is no limitation of halftone types when extracting the halftone positions.

S30: inputting the halftone position and the halftone training samples into a Generative Adversarial Networks (GANs) generator to generate a simulation image, and obtaining a second error function based on the simulation image and the non-halftone training samples.

Wherein, Generative Adversarial Networks (GAN) is a deep learning model and one of unsupervised learning methods in complex distribution. The model learns to produce output that is quite close to people's expectation through the mutual game of (at least) two modules in the framework: a Generative Model and a Discriminative Model. Understandably, the Generative Adversarial Networks is actually updating and optimizing its own models (including Generative Model and Discriminative Model) according to the mutual game between the Generative Model and Discriminative Model. The Generative Model is responsible for generating outputs that are highly similar to the training samples, while the Discriminative Model is responsible for determining the authenticity of outputs that are highly similar to the training samples generated by the Generative Model. With the increase of training frequencies, the “simulation” ability of the Generative Model will be stronger, the output will be closer to the training samples, and the discrimination ability of the Discriminative Model will also be stronger, which can identify the highly “simulation” output generated by the Generative Model. When the probability of discrimination of the final Discriminative Model is about 50%, it means that the Generative Model can no longer distinguish truth from falsehood (literally a wild guess), and the simulation samples generated by the Generative Model are almost the same as the real training samples. The simulation image is the image generated by the Generative Adversarial Networks generator, which can be known from the characteristics of the Generative Adversarial Networks generator. In one embodiment, the Generative Adversarial Networks generator refers to the Generative Model of the Generative Adversarial Networks.

In one embodiment, the halftone position and the halftone training sample extracted by the halftone extractor are input into the Generative Adversarial Networks generator (which is also a model), and the Generative Adversarial Networks generator generates a corresponding simulation image according to the halftone position and the halftone training sample. Specifically, the Generative Adversarial Networks generator processes the input halftone position and halftone training sample through the network parameters (weight and bias) in the generator, and calculates to obtain simulation image. Because the simulation image is generated, it only simulates and approximates the “appearance” of the non-halftone training sample to the greatest extent. After the simulation image is obtained, the second error function (i.e. l_loss) is obtained according to the simulation image and the non-halftone training sample (i.e. the actual situation, which functions as a label here). L_loss refers to the error function constructed according to the error between the simulation image generated by the Generative Adversarial Networks generator and the actual situation (non-halftone training samples). Specifically, the error function l_loss constructed according to the error between the simulation image and the actual situation can carry out error backpropagation on the network parameters in the Generative Adversarial Networks generator and update the network parameters of the Generative Adversarial Networks generator.

In a specific embodiment, the step S30 of inputting the halftone position and the halftone training samples into a Generative Adversarial Networks (GANs) generator to generate a simulation image, and obtaining l_loss based on the simulation image and the non-halftone training samples includes: the calculation formula of l_loss is

$$l\_loss = \sqrt{{\sum }_{i = 1}^{n} {( {x}_{i} - {y}_{i} )}^{2}} ,$$

wherein n is the number of pixel values, xᵢ represents the i-th pixel value of the simulation image, yᵢ represents the i-th pixel value of the non-halftone training sample corresponding to Preferably, in order to facilitate the calculation, the pixel values represented by xᵢ and yᵢ here are normalized before performing the calculation of error function, which can effectively simplify the calculation and speed up the training process of the descreening system.

S40: inputting the simulation image and the non-halftone training samples into a Generative Adversarial Networks discriminator to obtain a discrimination result, and obtaining a third error function and a fourth error function according to the discrimination result.

In one embodiment, the simulation image and the non-halftone training sample are input into a Generative Adversarial Networks discriminator to obtain a discrimination result. Wherein, the Generative Adversarial Networks discriminator is a network model corresponding to the Generative Adversarial Networks generator, configured for discriminating the authenticity of the simulation image generated by the Generative Adversarial Networks generator. That is, the Generative Adversarial Networks discriminator refers to the Discriminative Model of the Generative Adversarial Networks. Acquiring a third error function (gan_g_loss) and a fourth error function (gan_d_loss) according to the discrimination result of the Generative Adversarial Networks discriminator, wherein gan_g_loss is an error function reflecting the simulation image generated by the Generative Adversarial Networks generator, and can carry out error back backpropagation on the network parameters in the Generative Adversarial Networks generator and update the network parameters according to the error function; gan_d_loss is an error function reflecting the judgment of simulation image by the Generative Adversarial Networks discriminator, and can carry out error backpropagation on the network parameters in the Generative Adversarial Networks discriminator and update the network parameters in the Generative Adversarial Networks discriminator.

In a specific embodiment, the step S40 of inputting the simulation image and the non-halftone training samples into a Generative Adversarial Networks discriminator to obtain a discrimination result, and obtaining gan_g_loss and gan_d_loss according to the discrimination result concretely includes: the discrimination results output by the Generative Adversarial Networks discriminator are D(G(X)) and D(Y), and X represents the input of the Generative Adversarial Networks generator. X consists of n xᵢ, xᵢ, represents the i-th pixel value input by the Generative Adversarial Networks generator, G(X) represents the output of the Generative Adversarial Networks generator, D(G(X)) represents the output of the Generative Adversarial Networks generator (i.e., simulation image, is the input of the Generative Adversarial Networks discriminator) in the output of the Generative Adversarial Networks discriminator (after discrimination), Y represents the input of the non-halftone training samples to the Generative Adversarial Networks discriminator, Y consists of n yᵢ, yᵢ represents the i-th pixel value of the non-halftone training sample input to the Generative Adversarial Networks discriminator, and D(Y) represents the output of the non-halftone training sample in the Generative Adversarial Networks discriminator. The calculation formula of gan_g_loss is

$$gan\_g \_loss = - \frac{1}{n} {\sum }_{i = 1}^{n} log D ( G ( {x}_{i} ) ) ,$$

wherein gan_g_loss is an error function describing the error that occurs when the Generative Adversarial Networks discriminator discriminates the output of the Generative Adversarial Networks generator. The calculation formula of gan_d_loss is

$$gan\_d \_loss = - \frac{1}{n} {\sum }_{i = 1}^{n} [ log D ( {y}_{i} ) + log ( 1 - D ( G ( {x}_{i} ) ) ) ] ,$$

wherein gan_d_loss is an error function describing the error that occurs when the Generative Adversarial Networks discriminator discriminates the non-halftone training samples. Preferably, the pixel values in step S40 are normalized before performing the calculation of error function, which can effectively simplify the calculation and speed up the training process of the descreening system.

S50: extracting feature A of the simulation image and feature B of the non-halftone training samples by adopting a pre-trained face recognition model, and obtaining a fifth error function according to the feature A and the feature B.

Wherein, the face recognition model is pre-trained, and the face recognition model can be obtained by training with open source face sets.

In one embodiment, extracting feature A of the simulation image and feature B of the non-halftone training samples by adopting a pre-trained face recognition model, and obtaining a fifth error function (i_loss) according to the feature A and the feature B. Understandably, the feature A of the simulation image and the feature B of the non-halftone training samples are extracted by the face recognition model, and the error function i_loss constructed according to the feature A and the feature B can reflect the similarity degree of fine features of the simulation image and the non-halftone training sample, and the fine features extracted by the face recognition model can reflect the feature difference between the simulation image and the non-halftone training sample. Based on this difference, an appropriate error function i_loss can be constructed, and the network parameters in the Generative Adversarial Networks generator and the network parameters in the Generative Adversarial Networks discriminator are updated according to i_loss, so that the simulation images generated by the Generative Adversarial Networks generator are more“true”, the discrimination ability of the Generative Adversarial Networks discriminator is more “stronger” (because the simulation images are used as input in the Generative Adversarial Network discriminator, errors also occur, i_loss can also update the network parameters in the Generative Adversarial Networks discriminator).

In a specific embodiment, as shown in FIG. 4, the step S50 of extracting feature A of the simulation image and feature B of the non-halftone training samples by adopting a pre-trained face recognition model, and obtaining i_loss according to the feature A and the feature B, includes the following steps:

S51: inputting the simulation image into the pre-trained face recognition model, extracting feature A.

In one embodiment, the face recognition model extracts the features of the simulation image by inputting the simulation image into the face recognition model, and extracting the features of the simulation image by the pre-trained face recognition model. The extracted feature is feature A, which can specifically refer to extracting each pixel value from the simulation image by the pre-trained face recognition model.

S52: inputting the non-halftone training sample into the pre-trained face recognition model, extracting feature B.

In one embodiment, the face recognition model extracts the features of the non-halftone training sample by inputting the non-halftone training sample into the face recognition model, and extracting the features of the non-halftone training sample by the pre-trained face recognition model. The extracted feature is feature B, which specifically refers to extracting each pixel value corresponding to feature A from the simulation image by the pre-trained face recognition model.

S53: calculating Euclidean distance between the feature A and feature B to obtain a fifth error function, wherein the calculation formula of the fifth error function is

$$i\_loss = \sqrt{{\sum }_{i = 1}^{n} {( {a}_{i} - {b}_{i} )}^{2}} ,$$

wherein n is the number of pixel values, aᵢ represents the i-th pixel value in the feature A, bᵢ represents the i-th pixel value in the feature B.

In one embodiment, the Euclidean distance is used as the error function of feature A and feature B. The error function can well describe the difference between feature A and feature B. The error function i_loss constructed according to this difference can update the network parameters in the Generative Adversarial Networks generator and the network parameters in the Generative Adversarial Networks discriminator by backpropagation, so that the generated simulation image can achieve almost the same effect as the non-halftone training sample.

Preferably, the pixel values represented by aᵢ and bᵢ here are normalized before performing the calculation of error function, which can effectively simplify the calculation and speed up the training process of the descreening system.

S60: obtaining a sixth error function, and updating network parameters of the Generative Adversarial Networks generator according to the sixth error function, wherein the sixth error function=the second error function+third error function+fifth error function.

Wherein, the sixth error function (g_loss) is the final error function used to update the network parameters in the Generative Adversarial Networks generator.

In one embodiment, g_loss is obtained, g_loss=l_loss+gan_g_loss+i_loss. Understandably, l_loss reflects the error between the simulation image generated by the Generative Adversarial Networks generator and the actual situation (non-halftone training samples); gan_g_loss reflects the error when the simulation image generated by the Generative Adversarial Networks generator is discriminated by the Generative Adversarial Networks discriminator (the error is reflected in the simulation image as the input of Generative Networks discriminator, is different from l_loss); i_loss reflects the feature difference (i.e. error) between the simulation image and the non-halftone training sample. The error functions in the sense of three different dimensions can all reflect the errors of the simulation images generated by the Generative Adversarial Networks generator. Therefore, these three error functions can all be used to update the network parameters in the Generative Adversarial Networks generator. Because these three error functions represent error functions in different dimensions, the combination of l_loss, gan_g_loss and i_loss can achieve very excellent training effect. The images generated by the Generative Adversarial Networks generator after updating network parameters are almost the same as the non-halftone training samples, which can achieve the effect of “as real ones”. It should be noted that the arithmetic symbol “+” in g_loss=l_loss+gan_g_loss+i_loss refers to arithmetic addition. The gradient descent method is adopted in the step of updating the network parameters by backpropagation of error function. The gradient descent method here is not limited to batch gradient descent method, mini-batch gradient descent method and stochastic gradient descent method.

S70: obtaining a seventh error function, and updating network parameters of the Generative Adversarial Networks discriminator according to the seventh error function, wherein the seventh error function=the fourth error function+fifth error function.

Wherein, the seventh error function (d_loss) is the final error function used to update the network parameters in the Generative Adversarial Networks discriminator. In one embodiment, d_loss is obtained, d_loss=gan_d_loss+i_loss. Understandably, gan_d_loss reflects the error occurred when the Generative Adversarial Networks discriminator discriminates the non-halftone training samples. i_loss reflects the error between the features extracted from simulation image and the non-halftone training sample by the face recognition model. The error can be reflected when the simulation image and the non-halftone training sample are used as input of the Generative Adversarial Networks discriminator. The error functions in two different dimensions can both reflect the errors of the discrimination result obtained by the Generative Adversarial Networks discriminator when discriminating. Therefore, these two error functions can be used to update the network parameters in the Generative Adversarial Networks discriminator. Because these two error functions represent error functions in different dimensions, combining gan_d_loss and i_loss can achieve very excellent training effect, making the discrimination ability of the updated Generative Adversarial Networks discriminator stronger, and further improving the ability of the Generative Adversarial Networks generator to generate simulation images, until the Generative Adversarial discrimination network is in a wild guess stage (the discrimination probability is 50%), making it difficult to distinguish between the simulation images generated by the Generative Adversarial Networks generator and the non-halftone training samples. It should be noted that the arithmetic symbol “+” in d_loss=gan_d_loss+i_loss refers to arithmetic addition. The gradient descent method is adopted in the step of updating the network parameters by backpropagation of error function. The gradient descent method here is not limited to batch gradient descent method, mini-batch gradient descent method and stochastic gradient descent method.

In the training method for descreening system provided by the embodiment, e_loss is obtained based on halftone position and a preset label value, the network parameters of the halftone extractor are updated according to e_loss by backpropagation, so that the updated halftone extractor is more accurate in extracting halftone positions of halftone training sample and non-halftone training sample data, and the accuracy of subsequent descreening system training is improved. Obtaining l_loss based on simulation images and non-halftone training samples, obtaining gan_g_loss and gan_d_loss according to discrimination results, obtaining i_loss according to features A and B, and based on the characteristics of the Generative Adversarial Networks (including the Generative Adversarial Networks generator and the Generative Adversarial Networks discriminator), the error function g_loss of the Generative Adversarial Networks generator and the error function d_loss of the Generative Adversarial Networks discriminator are obtained according to l_loss, gan_g_loss, gan_g_loss and i_loss, according to the errors generated by each model of the descreening training system, the corresponding error functions are constructed by different error functions in multiple dimensions, and after the error functions in multiple dimensions are added together, the network parameters of various model parts in the descreening system are updated by backpropagation according to the final error functions respectively used by the Generative Adversarial Networks generator and the Generative Adversarial Networks discriminator, to realize full and effective training of the descreening system. The descreening system covers every factor affecting the descreening effect of the descreening system in the training process of the descreening system, and each factor reflects the possible errors in the respective dimensions. According to the errors, an appropriate error function is constructed and the network parameters are updated by backpropagation, so that the entire descreening system is trained, and a very excellent effect can be achieved when the descreening system performs descreening operation on images.

It should be understood that the sequence number of each step in the above embodiment does not indicate the order of implementation, and the implementation order of each step should be determined by its function and internal logic, and should not constitute any limitation on the implementation process of the embodiments of the present application.

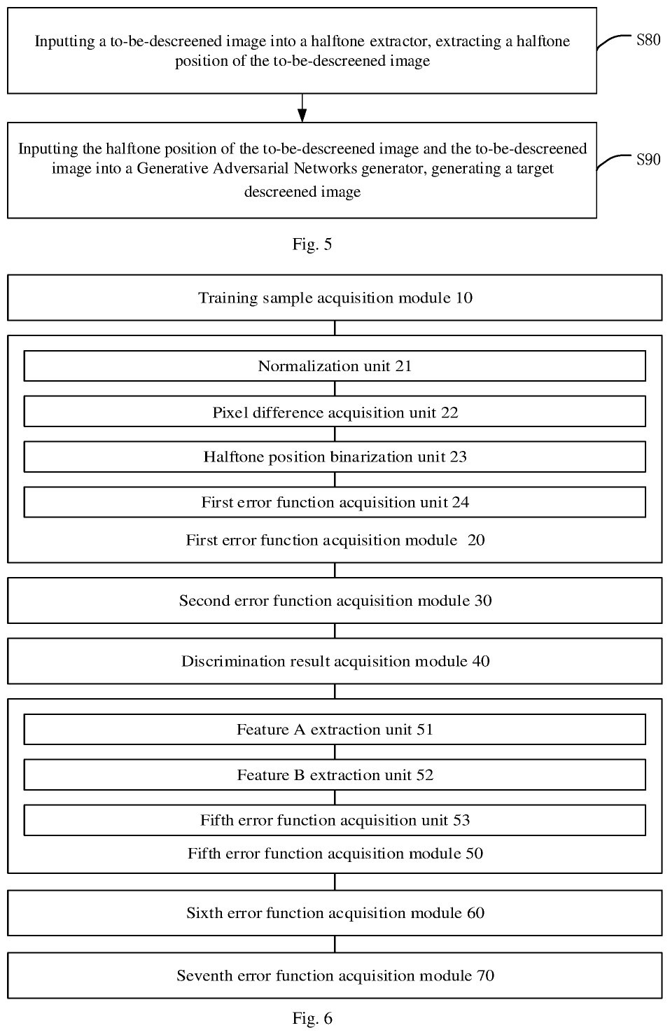

FIG. 5 shows a principle block diagram of the training device for descreening system corresponding to the training method for descreening system in the embodiment. As shown in FIG. 5, the training device for descreening system includes a training sample acquisition module 10, a first error function acquisition module 20, a second error function acquisition module 30, a discrimination result acquisition module 40, a fifth error function acquisition module 50, a sixth error function acquisition module 60, and a seventh error function acquisition module 70. Wherein, the implementation functions of the training sample acquisition module 10, first error function acquisition module 20, second error function acquisition module 30, discrimination result acquisition module 40, fifth error function acquisition module 50, sixth error function acquisition module 60, and seventh error function acquisition module 70 correspond to the steps corresponding to the training method for descreening system in the embodiment one by one. In order to avoid repetition, it will not be described in detail in this embodiment.

A training sample acquisition module 10, configured for extracting samples to be trained, wherein the to-be-trained samples comprise equal numbers of halftone training samples and non-halftone training samples.

A first error function acquisition module 20, configured for inputting the halftone training samples into a halftone extractor, extracting a halftone position, obtaining a first error function based on the halftone position and a preset label value, and updating network parameters of the halftone extractor according to the first error function.

A second error function acquisition module 30, configured for inputting the halftone position and the halftone training samples into a Generative Adversarial Networks (GANs) generator to generate a simulation image, and obtaining a second error function based on the simulation image and the non-halftone training samples.

A discrimination result acquisition module 40, configured for inputting the simulation image and the non-halftone training samples into a Generative Adversarial Networks discriminator to obtain a discrimination result, and obtaining a third error function and a fourth error function according to the discrimination result.

A fifth error function acquisition module 50, configured for extracting feature A of the simulation image and feature B of the non-halftone training samples by adopting a pre-trained face recognition model, and obtaining a fifth error function according to the feature A and the feature B.

A sixth error function acquisition module 60, configured for obtaining a sixth error function, and updating network parameters of the Generative Adversarial Networks generator according to the sixth error function, wherein the sixth error function=the second error function+third error function+fifth error function.

A seventh error function acquisition module 70, configured for obtaining a seventh error function, and updating network parameters of the Generative Adversarial Networks discriminator according to the seventh error function, wherein the seventh error function=the fourth error function+fifth error function.

Preferably, the first error function acquisition module 20 includes a normalization unit 21, a pixel difference acquisition unit 22, a halftone position binarization unit 23, and a first error function acquisition unit 24.

A normalization unit 21, configured for acquiring each pixel value of the halftone position, normalizing each pixel value, and acquiring a normalized pixel value; wherein the formula for acquiring normalized pixel values is

$$y = \frac{x - MinValue}{MaxValue - MinValue} ,$$

MaxValue represents the maximum value of all pixel values of the halftone position, MinValue represents the minimum value of all pixel values of the halftone position, X is each pixel value, and Y is normalized pixel value.

A pixel difference acquisition unit 22, configured for acquiring a pixel difference between the normalized pixel values of the halftone position and the corresponding non-halftone training sample.

A halftone position binarization unit 23, configured for if the pixel difference is greater than a preset boundary value, the normalized pixel value corresponding to the halftone position is taken as 1; if the pixel difference is not greater than the preset boundary value, the normalized pixel value corresponding to the halftone position is taken as 0, obtaining a binary halftone position.

A first error function acquisition unit 24, configured for calculating according to each pixel value of the binary halftone position and each pixel value corresponding to a preset label to obtain a first error function, and updating network parameters of the halftone extractor according to the first error function; wherein the calculation formula of the first error function is

$$e\_loss = - \frac{1}{n} {\sum }_{i = 1}^{n} [ {y}_{i} log {x}_{i} + ( 1 - {y}_{i} ) log ( 1 - {x}_{i} ) ] ,$$

wherein n is the number of pixel values, xᵢ represents the i-th pixel value of the binary halftone position, yᵢ represents a preset label value and is the binary halftone position corresponding to xᵢ.

Preferably, the calculation formula of the second error function is

$$l\_loss = \sqrt{{\sum }_{i = 1}^{n} {( {x}_{i} - {y}_{i} )}^{2}} ,$$

wherein n is the number of pixel values, xᵢ represents the i-th pixel value of the simulation image, yᵢ represents the i-th pixel value of the non-halftone training sample corresponding to xᵢ.

Preferably, the discrimination results are D(G(X)) and D(Y), X represents the input of the Generative Adversarial Networks generator, X consists of n xᵢ, xᵢ represents the i-th pixel value input by the Generative Adversarial Networks generator, and G(X) represents the output of the Generative Adversarial Networks generator, D(G(X)) represents the output of the Generative Adversarial Networks generator in the output of the Generative Adversarial Networks discriminator, Y represents the input of the non-halftone training sample in the Generative Adversarial Networks discriminator, Y consists of n yᵢ, yᵢ represents the i-th pixel value of the non-halftone training sample input to the Generative Adversarial Networks discriminator, and D(Y) represents the output of the non-halftone training sample in the Generative Adversarial Networks discriminator;

the calculation formula of the third error function is

$$gan\_g \_loss = - \frac{1}{n} {\sum }_{i = 1}^{n} log D ( G ( {x}_{i} ) ) ;$$

the calculation formula of the fourth error function is

$$gan\_d \_loss = - \frac{1}{n} {\sum }_{i = 1}^{n} [ log D ( {y}_{i} ) + log ( 1 - D ( G ( {x}_{i} ) ) ) ] .$$

Preferably, the fifth error function acquisition module 50 includes a feature A extraction unit 51, a feature B extraction unit 52, and a fifth error function acquisition unit 53.

A feature A extraction unit 51, configured for inputting the simulation image into the pre-trained face recognition model, extracting feature A.

A feature B extraction unit 52, configured for inputting the non-halftone training sample into the pre-trained face recognition model, extracting feature B.

A fifth error function acquisition unit 53, configured for calculating Euclidean distance between the feature A and feature B to obtain a fifth error function, wherein the calculation formula of the fifth error function is

$$i\_loss = \sqrt{{\sum }_{i = 1}^{n} {( {a}_{i} - {b}_{i} )}^{2}} ,$$

wherein n is the number of pixel values, aᵢ represents the i-th pixel value in the feature A, bᵢ represents the i-th pixel value in the feature B.

FIG. 6 shows a flowchart of the descreening method in an embodiment. The descreening method can be applied to computer apparatus in financial institutions such as banks, securities, investment, insurance and other institutions that need to remove halftone patterns from images, so as perform descreening process on pictures, realize artificial intelligence. Wherein, the computer apparatus is a human-machine interaction device, including but not limited to computers, smart phones and tablets. As shown in FIG. 6, the descreening method includes the following steps:

S80: inputting a to-be-descreened image into a halftone extractor, extracting a halftone position of the to-be-descreened image; the halftone extractor is obtained by updating network parameters of the halftone extractor based on a first error function, by adopting the training method for descreening system in the embodiment.

Wherein, the to-be-descreened image refers to the target image to be descreened.

In one embodiment, the to-be-descreened images are input into a halftone extractor, and the halftone positions of the to-be-descreened images are extracted by the halftone extractor, which provides a technical premise for generating target descreened images according to the halftone positions. The halftone extractor formed by updating the network parameters of the halftone extractor by adopting the first error function obtained by the training method for descreening system in the embodiment can accurately extract the halftone positions of the to-be-descreened images, thereby effectively improving the accuracy of the descreening process.

S90: inputting the halftone position of the to-be-descreened image and the to-be-descreened image into a Generative Adversarial Networks generator, generating a target descreened image; the Generative Adversarial Networks generator is obtained by updating network parameters of the Generative Adversarial Networks generator based on a sixth error function, by adopting the training method for descreening system in the embodiment.

Wherein, the target descreened image refers to the target image obtained after the to-be-descreened image being descreened.

In one embodiment, the halftone position of the to-be-descreened image extracted by the halftone extractor and the the to-be-descreened image are input into the Generative Adversarial Networks generator, and the Generative Adversarial Networks generator removes the halftone in the to-be-descreened image according to the halftone position to generate a target descreened image. The Generative Adversarial Networks generator formed by updating the network parameters of the Generative Adversarial Networks generator using the sixth error function obtained by the training method for the descreening system in the embodiment can accurately remove the halftone in the to-be-descreened image, thereby effectively improving the descreening effect.

In the descreening method provided by the embodiment, firstly, the halftone position of the to-be-descreened image is extracted by the halftone extractor, and the halftone extractor formed after the network parameters of the halftone extractor are updated by adopting the first error function obtained by the training method for descreening system in the embodiment can accurately extract the halftone position of the to-be-descreened image, thereby effectively improving the accuracy of the halftone extraction. And then removing the halftone of the to-be-descreened image according to the halftone position by the Generative Adversarial Networks generator. The gGenerative Adversarial Networks generator formed after updating the network parameters of the Generative Adversarial Networks generator by adopting the sixth error function obtained by the training method for descreening system in the embodiment can remove the halftone of the to-be-descreened image accurately, thus effectively improving the descreening effect; and the target descreened image generated by the descreening method is almost the same as the corresponding image before screened, thus achieving an excellent descreening effect.

It should be understood that the sequence number of each step in the above embodiment does not indicate the order of implementation, and the implementation order of each step should be determined by its function and internal logic, and should not constitute any limitation on the implementation process of the embodiments of the present application.

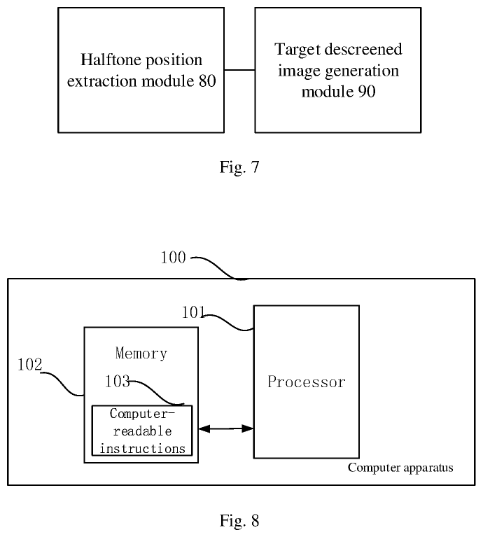

FIG. 7 shows a principle block diagram of the descreening device corresponding to the descreening method in the embodiment. As shown in FIG. 7, the descreening device includes a halftone position extraction module 80 and a target descreened image generation module 90. Wherein, the implementation functions of the halftone position extraction module 80 and the target descreened image generation module 90 correspond to the steps corresponding to the descreening method in the embodiment one by one. In order to avoid repetition, this embodiment will not detail them.

A halftone position extraction module 80, configured for inputting a to-be-descreened image into a halftone extractor, extracting a halftone position of the to-be-descreened image; the halftone extractor is obtained by updating network parameters of the halftone extractor based on a first error function, by adopting the training method for descreening system in the embodiment.

A target descreened image generation module 90, configured for inputting the halftone position of the to-be-descreened image and the to-be-descreened image into a Generative Adversarial Networks generator, generating a target descreened image; the Generative Adversarial Networks generator is obtained by updating network parameters of the Generative Adversarial Networks generator based on a sixth error function, by adopting the training method for descreening system in the embodiment.

This embodiment provides a computer-readable storage medium on which computer-readable instructions are stored. When the computer-readable instructions are executed by a processor, the training method for descreening system in the embodiment is implemented. In order to avoid repetition, the details are not repeated here. Alternatively, when the computer-readable instructions are executed by the processor, the functions of each module/unit of the training device for descreening system in the embodiment are realized. In order to avoid repetition, it is not repeated here. Alternatively, when the computer-readable instructions are executed by the processor, the functions of each step of the descreening method in the embodiment are realized. In order to avoid repetition, it is not repeated here. Alternatively, when the computer-readable instructions are executed by the processor, the functions of each module/unit of the descreening device in the embodiment are realized. In order to avoid repetition, it is not repeated here.

FIG. 8 is a schematic diagram of the computer apparatus in an embodiment of the present application. As shown in FIG. 8, the computer apparatus 100 of this embodiment includes a processor 101, a memory 102, and computer readable instructions 103 stored in the memory 102 and executable on the processor 101. When the computer readable instructions 103 are executed by the processor 101, the training method for descreening system in this embodiment is implemented. To avoid repetition, it is not repeated here. Alternatively, when the computer-readable instructions 103 are executed by the processor, the functions of each module/unit of the training device for descreening system in the embodiment are realized. In order to avoid repetition, it is not repeated here. Alternatively, when the computer-readable instructions 103 are executed by the processor 101, the functions of each step of the descreening method in the embodiment are realized. In order to avoid repetition, it is not repeated here. Alternatively, when the computer-readable instructions 103 are executed by the processor 101, the functions of each module/unit of the descreening device in the embodiment are realized. In order to avoid repetition, it is not repeated here.

Exemplarily, computer-readable instructions 103 may be divided into one or more modules/units, which are stored in memory 102 and executed by processor 101 to complete the present application. One or more modules/units may be instruction segments of a series of computer-readable instructions 103 capable of performing specific functions, which are used to describe the execution process of the computer-readable instructions 103 in the computer apparatus 100. For example, in the embodiment, the computer-readable instruction 103 may be divided into a training sample acquisition module 10, a first error function acquisition module 20, a second error function acquisition module 30, a discrimination result acquisition module 40, a fifth error function acquisition module 50, a sixth error function acquisition module 60, and a seventh error function acquisition module 100, or a halftone position extraction module 80 and a target descreened image generation module 90. The specific functions of each module are shown in the embodiment, and will not be described here in detail to avoid repetition.

The computer apparatus 100 may be a desktop computer, a notebook computer, a palm computer, a cloud server, or other computer devices. Computer devices may include, but are not limited to, a processor 101 and a memory 102. Those skilled in the art will understand that FIG. 8 is only an example of the computer device 100 and does not constitute a limitation on the computer apparatus 100. It may include more or fewer components than those shown in the figures, or some components may be combined, or different components, for example, the computer apparatus may also include input and output devices, network access devices, buses, etc.

The processor 101 may be a Central Processing Unit (CPU), other general purpose processors, Digital Signal Processor (DSP), Application Specific Integrated Circuits, ASIC), Field-Programmable Gate Array (FPGA) or other programmable logic devices, discrete gates or transistor logic devices, discrete hardware components, etc. The general-purpose processor may be a microprocessor or the processor may be any conventional processor or the like.

The memory 102 may be an internal storage unit of the computer apparatus 100, such as a hard disk or memory of the computer apparatus 100. The memory 102 may also be an external storage device of the computer apparatus 100, such as a plug-in hard disk, a Smart Media Card (SMC), a Secure Digital card (SD), a Flash Card, etc. Further, the memory 102 may also include both internal storage units and external storage devices of the computer apparatus 100. The memory 102 is used to store computer-readable instructions 103 and other programs and data required by the computer apparatus. The memory 102 may also be used to temporarily store data that have been output or are to be output.

Those skilled in the art can clearly understand that, for convenience and conciseness of description, only the division of the above-mentioned functional units and modules will be illustrated. In actual application, the above-mentioned function distribution can be completed by different functional units and modules as required, i.e. the internal structure of the device is divided into different functional units or modules to complete all or parts of the above-mentioned functions. Further, the singular terms “a”, “an” and “the” include plural reference and vice versa unless the context clearly indicates otherwise.

In addition, each functional unit in each embodiment of the present application may be integrated into one processing unit, each unit may exist physically apart, or two or more units may be integrated into one unit. The above integrated units can be implemented in the form of hardware or functional software units.

The above-mentioned embodiments are only used to illustrate the technical solution of the present application, and are not intended to limit it. Although the application has been described in detail with reference to the foregoing embodiments, those skilled in the art should understand, that the technical solution described in the previous embodiments can still be modified or some of its technical features can be equally replaced. However, these modifications or substitutions do not cause the nature of the corresponding technical solutions to depart from the spirit and scope of the technical solutions of the embodiments of this application, and should be included in the scope of protection of this application.

1. A training method for descreening system, comprising:
extracting samples to be trained, wherein the to-be-trained samples comprise equal numbers of halftone training samples and non-halftone training samples;
inputting the halftone training samples into a halftone extractor, extracting a halftone position, obtaining a first error function based on the halftone position and a preset label value, and updating network parameters of the halftone extractor according to the first error function;
inputting the halftone position and the halftone training samples into a Generative Adversarial Networks (GANs) generator to generate a simulation image, and obtaining a second error function based on the simulation image and the non-halftone training samples;
inputting the simulation image and the non-halftone training samples into a Generative Adversarial Networks discriminator to obtain a discrimination result, and obtaining a third error function and a fourth error function according to the discrimination result;
extracting feature A of the simulation image and feature B of the non-halftone training samples by adopting a pre-trained face recognition model, and obtaining a fifth error function according to the feature A and the feature B;
obtaining a sixth error function, and updating network parameters of the Generative Adversarial Networks generator according to the sixth error function, wherein the sixth error function=the second error function+third error function+fifth error function;
obtaining a seventh error function, and updating network parameters of the Generative Adversarial Networks discriminator according to the seventh error function, wherein the seventh error function=the fourth error function+fifth error function.

2. The training method for descreening system of claim 1, wherein the step of obtaining a first error function based on the halftone position and a preset label value, and updating network parameters of the halftone extractor according to the first error function comprises:
acquiring each pixel value of the halftone position, normalizing each pixel value, and acquiring a normalized pixel value; wherein the formula for acquiring normalized pixel values is
$$y = \frac{x - MinValue}{MaxValue - MinValue} ,$$
MaxValue represents the maximum value of all pixel values of the halftone position, MinValue represents the minimum value of all pixel values of the halftone position, X is each pixel value, and Y is normalized pixel value;
acquiring a pixel difference between the normalized pixel values of the halftone position and the corresponding non-halftone training sample;
if the pixel difference is greater than a preset boundary value, the normalized pixel value corresponding to the halftone position is taken as 1; if the pixel difference is not greater than the preset boundary value, the normalized pixel value corresponding to the halftone position is taken as 0, obtaining a binary halftone position;
calculating according to each pixel value of the binary halftone position and each pixel value corresponding to a preset label to obtain a first error function, and updating network parameters of the halftone extractor according to the first error function; wherein the calculation formula of the first error function is
$$e\_loss = - \frac{1}{n} {\sum }_{i = 1}^{n} [ {y}_{i} log {x}_{i} + ( 1 - {y}_{i} ) log ( 1 - {x}_{i} ) ] ,$$
wherein n is the number of pixel values, xᵢ represents the i-th pixel value of the binary halftone position, yᵢ represents a preset label value and is the binary halftone position corresponding to xᵢ.

3. The training method for descreening system of claim 1, characterized in that the calculation formula of the second error function is
$$l\_loss = \sqrt{{\sum }_{i = 1}^{n} {( {x}_{i} - {y}_{i} )}^{2}} ,$$
wherein n is the number of pixel values, xᵢ represents the i-th pixel value of the simulation image, yᵢ represents the i-th pixel value of the non-halftone training sample corresponding to xᵢ.

4. The training method for descreening system of claim 1, wherein the discrimination results are D(G(X)) and D(Y), X represents the input of the Generative Adversarial Networks generator, X consists of n xᵢ, xᵢ represents the i-th pixel value input by the Generative Adversarial Networks generator, and G(X) represents the output of the Generative Adversarial Networks generator, D(G(X)) represents the output of the Generative Adversarial Networks generator in the output of the Generative Adversarial Networks discriminator, Y represents the input of the non-halftone training sample in the Generative Adversarial Networks discriminator, Y consists n yᵢ, yᵢ represents the i-th pixel value of the non-halftone training sample input to the Generative Adversarial Networks discriminator, and D(Y) represents the output of the non-halftone training sample in the Generative Adversarial Networks discriminator;
the calculation formula of the third error function is
$$gan\_g \_loss = - \frac{1}{n} {\sum }_{i = 1}^{n} log D ( G ( {x}_{i} ) ) ;$$
the calculation formula of the fourth error function is
$$gan\_d \_loss = - \frac{1}{n} {\sum }_{i = 1}^{n} [ log D ( {y}_{i} ) + log ( 1 - D ( G ( {x}_{i} ) ) ) ] .$$

5. The training method for descreening system of claim 1, wherein the step of extracting feature A of the simulation image and feature B of the non-halftone training samples by adopting a pre-trained face recognition model, and obtaining a fifth error function according to the feature A and the feature B comprises:
inputting the simulation image into the pre-trained face recognition model, extracting feature A;
inputting the non-halftone training sample into the pre-trained face recognition model, extracting feature B;
calculating Euclidean distance between the feature A and feature B to obtain a fifth error function, wherein the calculation formula of the fifth error function is
$$i\_loss = \sqrt{{\sum }_{i = 1}^{n} {( {a}_{i} - {b}_{i} )}^{2}} ,$$
wherein n is the number of pixel values, aᵢ represents the i-th pixel value in the feature A, bᵢ represents the i-th pixel value in the feature B.

6. A descreening method, comprising:
inputting a to-be-descreened image into a halftone extractor, extracting a halftone position of the to-be-descreened image; the halftone extractor is obtained by updating network parameters of the halftone extractor based on a first error function, by adopting the training method for descreening system mentioned in claim 1;
inputting the halftone position of the to-be-descreened image and the to-be-descreened image into a Generative Adversarial Networks generator, generating a target descreened image; the Generative Adversarial Networks generator is obtained by updating network parameters of the Generative Adversarial Networks generator based on a sixth error function, by adopting the training method for descreening system mentioned in claim 1.

7. (canceled)

8. (canceled)

9. A computer apparatus, comprising a memory, a processor, and computer readable instructions stored in the memory and executed by the processor, wherein the processor implements the following steps when executing the computer readable instructions:
extracting samples to be trained, wherein the to-be-trained samples comprise equal numbers of halftone training samples and non-halftone training samples;
inputting the halftone training samples into a halftone extractor, extracting a halftone position, obtaining a first error function based on the halftone position and a preset label value, and updating network parameters of the halftone extractor according to the first error function;
inputting the halftone position and the halftone training samples into a Generative Adversarial Networks (GANs) generator to generate a simulation image, and obtaining a second error function based on the simulation image and the non-halftone training samples;
inputting the simulation image and the non-halftone training samples into a Generative Adversarial Networks discriminator to obtain a discrimination result, and obtaining a third error function and a fourth error function according to the discrimination result;
extracting feature A of the simulation image and feature B of the non-halftone training samples by adopting a pre-trained face recognition model, and obtaining a fifth error function according to the feature A and the feature B;
obtaining a sixth error function, and updating network parameters of the Generative Adversarial Networks generator according to the sixth error function, wherein the sixth error function=the second error function+third error function+fifth error function;
obtaining a seventh error function, and updating network parameters of the Generative Adversarial Networks discriminator according to the seventh error function, wherein the seventh error function=the fourth error function+fifth error function.

10. The computer apparatus of claim 9, wherein the processor implements the following steps when executing the computer readable instructions:
acquiring each pixel value of the halftone position, normalizing each pixel value, and acquiring a normalized pixel value; wherein the formula for acquiring normalized pixel values is
$$y = \frac{x - MinValue}{MaxValue - MinValue} ,$$
MaxValue represents the maximum value of all pixel values of the halftone position, MinValue represents the minimum value of all pixel values of the halftone position, X is each pixel value, and Y is normalized pixel value;
acquiring a pixel difference between the normalized pixel values of the halftone position and the corresponding non-halftone training sample;
if the pixel difference is greater than a preset boundary value, the normalized pixel value corresponding to the halftone position is taken as 1; if the pixel difference is not greater than the preset boundary value, the normalized pixel value corresponding to the halftone position is taken as 0, obtaining a binary halftone position;
calculating according to each pixel value of the binary halftone position and each pixel value corresponding to a preset label to obtain a first error function, and updating network parameters of the halftone extractor according to the first error function; wherein the calculation formula of the first error function is
$$e\_loss = - \frac{1}{n} {\sum }_{i = 1}^{n} [ {y}_{i} log {x}_{i} + ( 1 - {y}_{i} ) log ( 1 - {x}_{i} ) ] ,$$
wherein n is the number of pixel values, xᵢ represents the i-th pixel value of the binary halftone position, yᵢ represents a preset label value and is the binary halftone position corresponding to xᵢ.

11. The computer apparatus of claim 9, characterized in that the calculation formula of the second error function is
$$l\_loss = \sqrt{{\sum }_{i = 1}^{n} {( {x}_{i} - {y}_{i} )}^{2}} ,$$
wherein n is the number of pixel values, xᵢ represents the i-th pixel value of the simulation image, yᵢ represents the i-th pixel value of the non-halftone training sample corresponding to xᵢ.

12. The computer apparatus of claim 9, wherein the discrimination results are D(G(X)) and D(Y), X represents the input of the Generative Adversarial Networks generator, X consists of n xᵢ, xᵢ represents the i-th pixel value input by the Generative Adversarial Networks generator, and G(X) represents the output of the Generative Adversarial Networks generator, D(G(X)) represents the output of the Generative Adversarial Networks generator in the output of the Generative Adversarial Networks discriminator, Y represents the input of the non-halftone training sample in the Generative Adversarial Networks discriminator, Y consists of n yᵢ, yᵢ represents the i-th pixel value of the non-halftone training sample input to the Generative Adversarial Networks discriminator, and D(Y) represents the output of the non-halftone training sample in the Generative Adversarial Networks discriminator;
the calculation formula of the third error function is
$$gan\_g \_loss = - \frac{1}{n} {\sum }_{i = 1}^{n} log D ( G ( {x}_{i} ) ) ;$$
the calculation formula of the fourth error function is
$$gan\_d \_loss = - \frac{1}{n} {\sum }_{i = 1}^{n} [ log D ( {y}_{i} ) + log ( 1 - D ( G ( {x}_{i} ) ) ) ] .$$

13. The computer apparatus of claim 9, wherein the processor implements the following steps when executing the computer readable instructions:
inputting the simulation image into the pre-trained face recognition model, extracting feature A;
inputting the non-halftone training sample into the pre-trained face recognition model, extracting feature B;
calculating Euclidean distance between the feature A and the feature B to obtain a fifth error function, wherein the calculation formula of the fifth error function is
$$i\_loss = \sqrt{{\sum }_{i = 1}^{n} {( {a}_{i} - {b}_{i} )}^{2}} ,$$
wherein n is the number of pixel values, aᵢ represents the i-th pixel value in the feature A, bᵢ represents the i-th pixel value in the feature B.

14. A computer apparatus, comprising a memory, a processor, and computer readable instructions stored in the memory and executed by the processor, wherein the processor implements the following steps when executing the computer readable instructions:
inputting a to-be-descreened image into a halftone extractor, extracting a halftone position of the to-be-descreened image; the halftone extractor is obtained by updating network parameters of the halftone extractor based on a first error function, by adopting the training method for descreening system mentioned in claim 1;
inputting the halftone position of the to-be-descreened image and the to-be-descreened image into a Generative Adversarial Networks generator, generating a target descreened image; the Generative Adversarial Networks generator is obtained by updating network parameters of the Generative Adversarial Networks generator based on a sixth error function, by adopting the training method for descreening system mentioned in claim 1.

15. A computer readable storage medium storing computer readable instructions, wherein when the computer readable instructions are executed by a processor, the following steps are implemented:
extracting samples to be trained, wherein the to-be-trained samples comprise equal numbers of halftone training samples and non-halftone training samples;
inputting the halftone training samples into a halftone extractor, extracting a halftone position, obtaining a first error function based on the halftone position and a preset label value, and updating network parameters of the halftone extractor according to the first error function;
inputting the halftone position and the halftone training samples into a Generative Adversarial Networks (GANs) generator to generate a simulation image, and obtaining a second error function based on the simulation image and the non-halftone training samples;
inputting the simulation image and the non-halftone training samples into a Generative Adversarial Networks discriminator to obtain a discrimination result, and obtaining a third error function and a fourth error function according to the discrimination result;
extracting feature A of the simulation image and feature B of the non-halftone training samples by adopting a pre-trained face recognition model, and obtaining a fifth error function according to the feature A and the feature B;
obtaining a sixth error function, and updating network parameters of the Generative Adversarial Networks generator according to the sixth error function, wherein the sixth error function=the second error function+third error function+fifth error function;
obtaining a seventh error function, and updating network parameters of the Generative Adversarial Networks discriminator according to the seventh error function, wherein the seventh error function=the fourth error function+fifth error function.

16. The computer readable storage medium of claim 15, wherein when the computer readable instructions are executed by a processor, the following steps are implemented:
acquiring each pixel value of the halftone position, normalizing each pixel value, and acquiring a normalized pixel value; wherein the formula for acquiring normalized pixel values is
$$y = \frac{x - MinValue}{MaxValue - MinValue} ,$$
MaxValue represents the maximum value of all pixel values of the halftone position, MinValue represents the minimum value of all pixel values of the halftone position, X is each pixel value, and Y is normalized pixel value;
acquiring a pixel difference between the normalized pixel values of the halftone position and the corresponding non-halftone training sample;
if the pixel difference is greater than a preset boundary value, the normalized pixel value corresponding to the halftone position is taken as 1; if the pixel difference is not greater than the preset boundary value, the normalized pixel value corresponding to the halftone position is taken as 0, obtaining a binary halftone position;
calculating according to each pixel value of the binary halftone position and each pixel value corresponding to a preset label to obtain a first error function, and updating network parameters of the halftone extractor according to the first error function; wherein the calculation formula of the first error function is
$$e\_loss = - \frac{1}{n} {\sum }_{i = 1}^{n} [ {y}_{i} log {x}_{i} + ( 1 - {y}_{i} ) log ( 1 - {x}_{i} ) ] ,$$
wherein n is the number of pixel values, xᵢ represents the i-th pixel value of the binary halftone position, yᵢ represents a preset label value and is the binary halftone position corresponding to xᵢ.

17. The computer readable storage medium of claim 15, characterized in that the calculation formula of the second error function is
$$l\_loss = \sqrt{{\sum }_{i = 1}^{n} {( {x}_{i} - {y}_{i} )}^{2}} ,$$
wherein n is the number of pixel values, xᵢ represents the i-th pixel value of the simulation image, yᵢ represents the i-th pixel value of the non-halftone training sample corresponding to xᵢ.

18. The computer readable storage medium of claim 15, wherein the discrimination results are D(G(X)) and D(Y), X represents the input of the Generative Adversarial Networks generator, X consists of n xᵢ, xᵢ represents the i-th pixel value input by the Generative Adversarial Networks generator, and G(X) represents the output of the Generative Adversarial Networks generator, D(G(X)) represents the output of the Generative Adversarial Networks generator in the output of the Generative Adversarial Networks discriminator, Y represents the input of the non-halftone training sample in the Generative Adversarial Networks discriminator, Y consists n yᵢ, yᵢ represents the i-th pixel value of the non-halftone training sample input to the Generative Adversarial Networks discriminator, and D(Y) represents the output of the non-halftone training sample in the Generative Adversarial Networks discriminator;
the calculation formula of the third error function is
$$gan\_g \_loss = - \frac{1}{n} {\sum }_{i = 1}^{n} log D ( G ( {x}_{i} ) ) ;$$
the calculation formula of the fourth error function is
$$gan\_d \_loss = - \frac{1}{n} {\sum }_{i = 1}^{n} [ log D ( {y}_{i} ) + log ( 1 - D ( G ( {x}_{i} ) ) ) ] .$$

19. The computer readable storage medium of claim 15, wherein when the computer readable instructions are executed by a processor, the following steps are implemented:
inputting the simulation image into the pre-trained face recognition model, extracting feature A;
inputting the non-halftone training sample into the pre-trained face recognition model, extracting feature B;
calculating Euclidean distance between the feature A and the feature B to obtain a fifth error function, wherein the calculation formula of the fifth error function is
$$i\_loss = \sqrt{{\sum }_{i = 1}^{n} {( {a}_{i} - {b}_{i} )}^{2}} ,$$
wherein n is the number of pixel values, aᵢ represents the i-th pixel value in the feature A, bᵢ represents the i-th pixel value in the feature B.

20. A computer readable storage medium storing computer readable instructions, wherein when the computer readable instructions are executed by a processor, the following steps are implemented:
inputting a to-be-descreened image into a halftone extractor, extracting a halftone position of the to-be-descreened image; the halftone extractor is obtained by updating network parameters of the halftone extractor based on a first error function, by adopting the training method for descreening system mentioned in claim 1;
inputting the halftone position of the to-be-descreened image and the to-be-descreened image into a Generative Adversarial Networks generator, generating a target descreened image; the Generative Adversarial Networks generator is obtained by updating network parameters of the Generative Adversarial Networks generator based on a sixth error function, by adopting the training method for descreening system mentioned in claim 1.
